(19) United States
(12) Patent Application Publication
(10) Pub. No.: US 2002/0063993 A1
(43) Pub. Date: May 30, 2002

(54) Oscilating head cleaner

(76) Inventor: David L. Hall, Salt Lake City, UT (US)

Correspondence Address: Richard E. Kurtz, WOODCOCK WASHBURN KURTZ, MACKIEWICZ & NORRIS LLP, One Liberty Place - 46th Floor, Philadelphia, PA, 19103, US

(21) Appl. No.: 09/725,731

(22) Filed: Nov. 29, 2000

(51) Int. Cl. G11B 3/58; G11B 33/14; G11B 5/41

(52) U.S. Cl. 360/128; 369/71; 360/97.02

(57) ABSTRACT

In a magnetic disk drive a cleaning pad is reciprocated in the direction of motion along the tracks of the disk. This motion along the tracks of the disk combined with cross track motion imparted by the actuator provides particularly effective removal from debris on the surfaces of the head. Linear and rotary actuators are used with the head cleaning device. A solenoid, a voice coil motor, a swash plate or a rotary motor having a connecting rod connected to the cleaning pad move the pad in a linear motion.

### FIELD OF THE INVENTION

This invention relates to magnetic and optical disk drives, and more particularly, to a head cleaner which provides head cleaning motion in the direction of the tracks on the disks.

### BACKGROUND OF THE INVENTION

In both rigid and floppy disk drives the cleaning of the head is commonly accomplished by using a cleaning medium which is rotated in the same manner that the normal data disk is rotated. U.S. Pat. No. 4,663,686, Freeman, et al. describes a head cleaning cartridge for removable cartridge magnetic disk drives. While such cartridges do effectively clean the heads, it is desirable to have a head cleaner in the drive itself so that cleaning will be accomplished routinely without the need for an operator to insert the head cleaning cartridge. U.S. Pat. No. 5,237,477, Hoddap describes a head cleaner which is in the drive.

U.S. Pat. No. 5,768,059, Bishop et al. shows a head cleaner for the ZIPTM drive. The drive has a linear actuator which moves the head across the disk to access the concentric tracks of the disk. These drives have a cleaning pad. The actuator moves the head across the cleaning pad in a motion which is across the tracks of the disk. The ZIPTM drive has a disk with a capacity of up to 250 megabytes and the drives are evolving toward higher and higher capacity disks. The ORB™ drive supplied by Castlewood has an elaborate load ramp which moves the head across a cleaning pad in the cross track direction.

Other attempts have been made to improve the cleaning of the disk because dirt and debris are a limiting factor in increasing the storage capacity of a drive. Contamination is particularly a problem in increasing the capacity of removable cartridge disk drives because they are not sealed. Fixed drives are normally assembled and sealed in a clean room whereby the disk and head are protected from contamination. However, in removable cartridge disk drives contaminants as small as the particles in cigarette smoke change the spacing between the magnetic head and the media and this affects the recording density.

It is an object of the present invention to improve head cleaning in a removable cartridge drive.

### SUMMARY OF THE INVENTION

In accordance with the present invention, relative motion between magnetic or optical heads and a cleaning pad in the direction of motion along the tracks of the disk cleans the heads.

In accordance with a preferred embodiment the cleaning pad is reciprocated along the direction of motion along the tracks in order to clean the head. Pad motion, oscillating or vibrating, relative to the heads and along the direction of track movement produces improved head cleaning.

By a combination of motion along the tracks and motion across the tracks in a controlled fashion, even the smallest debris can be removed from a head. Proper control of the across track motion by the actuator and the along the track motion by the head cleaner of the present invention results in improved cleaning.

The foregoing and other objects, features and advantages of the invention will be better understood from the following more detailed description and appended claims.

### SHORT DESCRIPTION OF THE DRAWINGS

FIG. 1 shows the disk drive with the cover removed;

FIG. 1A shows a cartridge of the type used in such a disk drive;

FIG. 2 shows the head loading/unloading mechanism;

FIG. 3 shows the head cleaner;

FIG. 4 shows the carriage in more detail,

FIG. 5 shows a close-up of the head cleaning device with the head cleaner being reciprocated by a connecting rod to a rotary motor;

FIG. 6 shows a voice coil motor used to reciprocate the head cleaner;

FIG. 7 shows a swash plate reciprocating the head cleaner; and

FIG. 8 depicts a rotary actuator with the head cleaner of the present invention.

### DESCRIPTION OF THE PREFERRED EMBODIMENTS

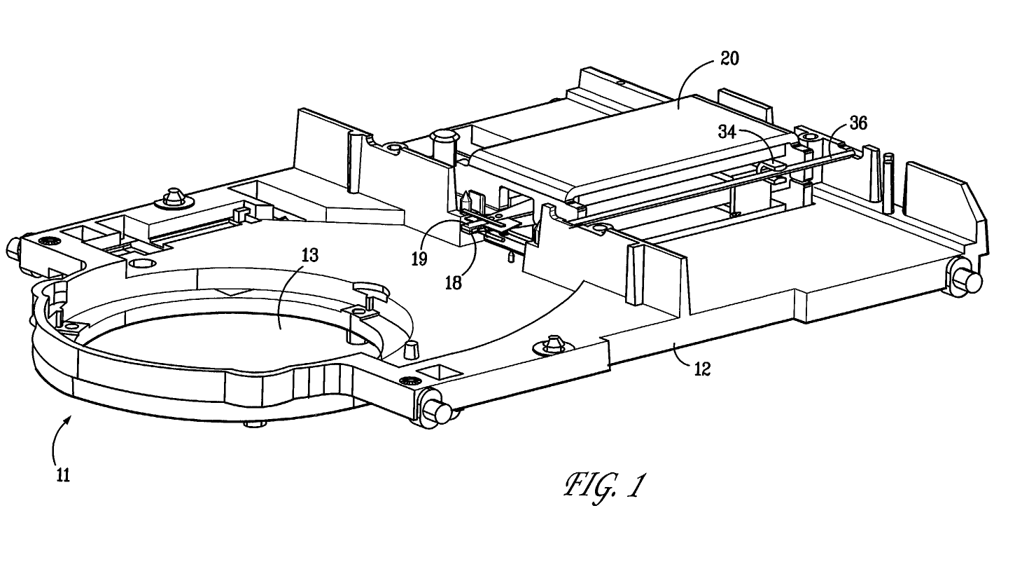

FIG. 1 shows a disk drive of the type in which a cartridge 10 (FIG. 1A) contains a recording media or disk 14. Disk 14 has concentric tracks 15 which contain data recorded thereon. The cartridge is inserted in the drive at 11 (FIG. 1). A spindle motor is mounted on platform 12 at 13. The motor rotates the flexible disk in the cartridge. The cartridge shown in FIG. 1A has a disk 14 with a hub 16 rotatably mounted therein to be rotated by the motor.

The disk is engaged by opposed read/write heads 18 and 19 which are carried by the actuator. Opposed heads engage both sides of the disk. The storage disk can be magnetic, magnetic-optical or optical. While a removable cartridge drive is the preferred embodiment the invention is applicable to a fixed disk drive.

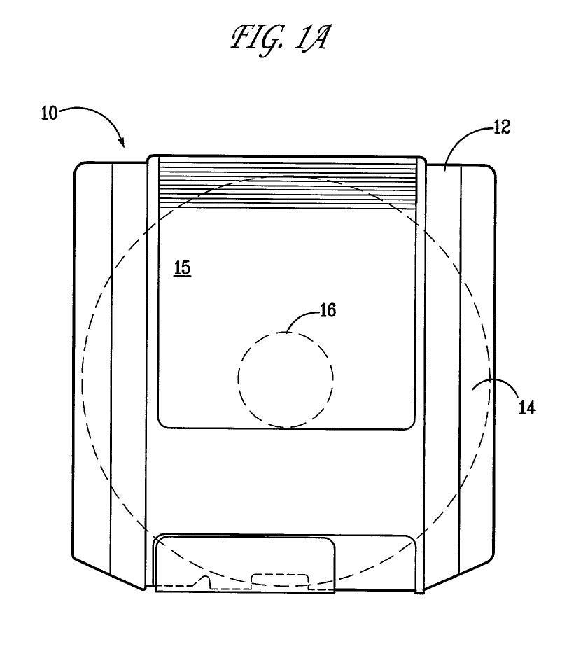

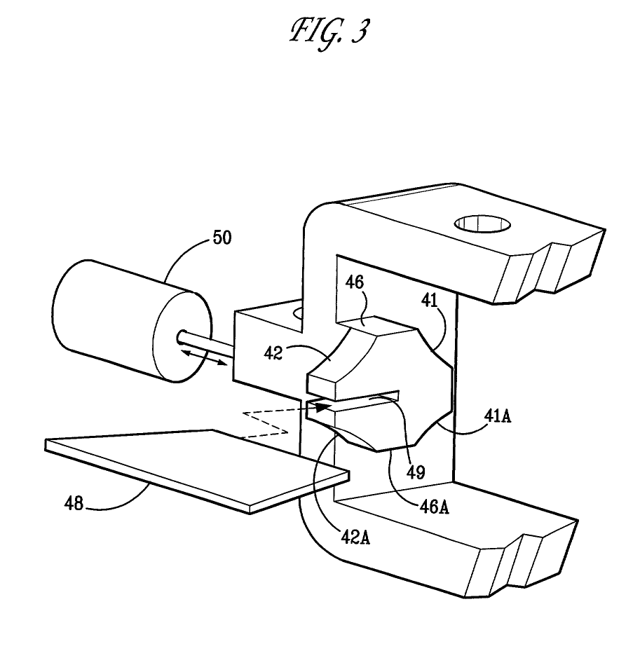

The actuator is a voice coil motor which carries the heads into and out of engagement of the heads with the recording medium. This voice coil motor includes an outer return path member 20 and a coil 22 (FIG. 2) mounted on the carriage assembly. When the coil 22 is energized, it interacts with the magnets to move the carriage linearly so that the heads 18 and 19 engage concentric tracks on the disk. The carriage includes two lightweight arms 24 and 26. The carriage travels on a central guide track 28 which is a cylindrical member, a small wire guide in the preferred embodiment. The carriage has two bushings through which the cylindrical guide track passes. (Bushing 30 is shown in FIG. 4).

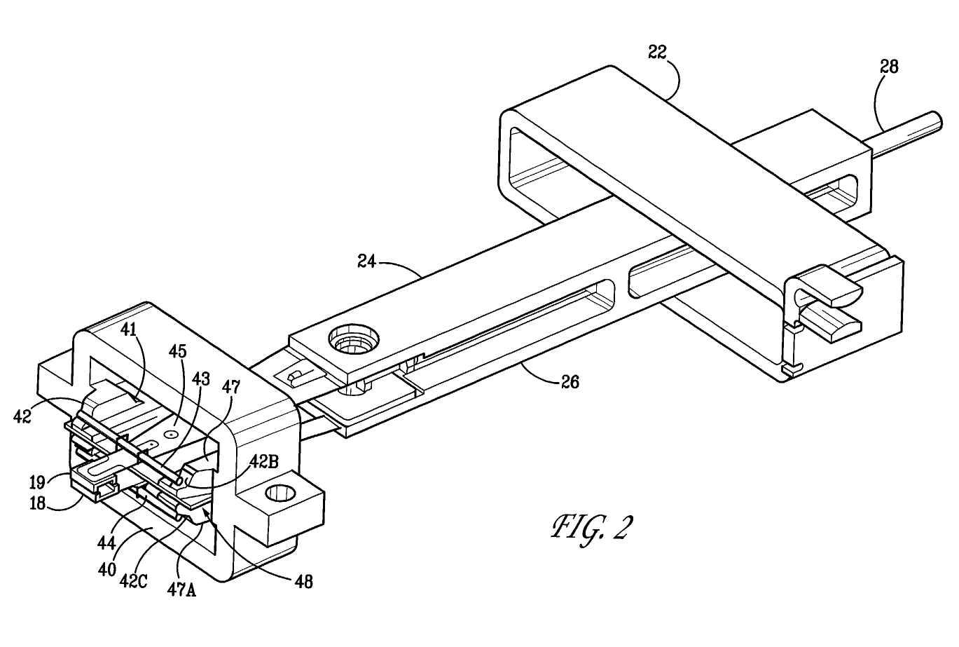

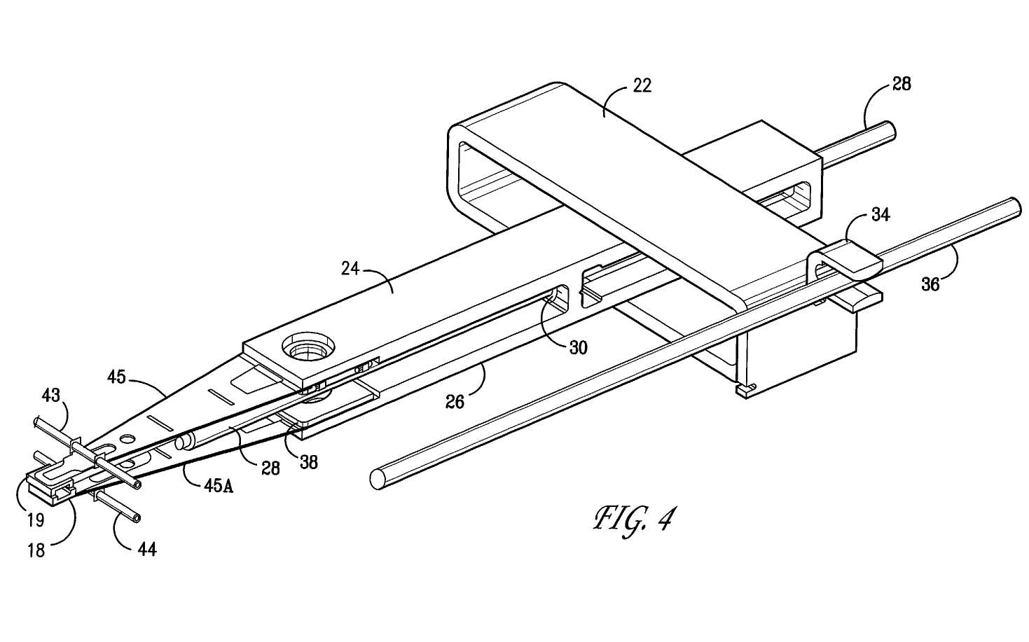

The head load/unload device 40 includes first opposed profiles 41 and 41A. In FIGS. 2 and 3, a set of complementary profiles on the other side of the suspension arm are not shown. Second opposed profiles 42 and 42A and complementary profiles 42B and 42C are provided. A typical profile is shown in FIG. 5. It has an arcuate contour which sets the heads down carefully on the disk or on the cleaning medium.

Wings 43 and 44 ride on the opposed profiles as the actuator carriage travels toward and away from the magnetic disk. In accordance with the preferred embodiment of the invention, the wings 43 and 44 are rods which are attached to the suspension arms 45 and 45A. Magnetic heads 18 and 19 are flexibly mounted on the suspension arms 45 and 45A (FIG. 4). The flexible mounting biases the heads toward each other. In FIGS. 2 and 4, the heads are shown biased together in the position in which they would engage opposite sides of the magnetic disk.

From the position shown in FIG. 2, as the actuator is retracted, the wings ride up on the second opposed profiles or cam surfaces, 42, 42A, 42B, 42C to separate the heads. This unloads the heads from the disk surface. Further travel of the actuator away from the disk causes the wings 43 and 44 to ride on the plateau surfaces 46, 46A, 47 and 47A. During continued travel of the actuator away from the disk, the wings ride down the second opposed profiles 41,41 A and the complementary set. This brings the heads onto the cleaning medium, or pad 48. The cleaning pad 48 is located in the slot 49 in the head load/unload device 40. The heads are parked on the cleaning pad 48. The contour of profiles 41,41A slides the heads along the cleaning pad 48 to clean the heads. Overtravel of the head on the cleaning pad provides cleaning in the cross back direction.

In accordance with the present invention a head cleaner moves the cleaning pad beneath the head in the direction of motion along the tracks of the disk. As shown in FIG. 3 a solenoid 50 reciprocates the pad 48 in the direction of motion along the tracks of the disk.

This motion of the heads on the cleaning pad can be combined with the cross track motion imparted to the heads by the actuator as the heads slide along the contoured profiles 41, 41A. This combination of motion along the tracks and across the tracks is particularly effective in cleaning debris from the heads or debris on the heads picked up from the disk.

As shown in FIG. 5 the head cleaner includes a rotary motor 52 having a connecting rod 54 which is off center to the rotation of the motor. This converts the rotary motion of the motor to reciprocating movement of the connecting rod to reciprocate the cleaning pad 48 in the direction along the tracks on the disk.

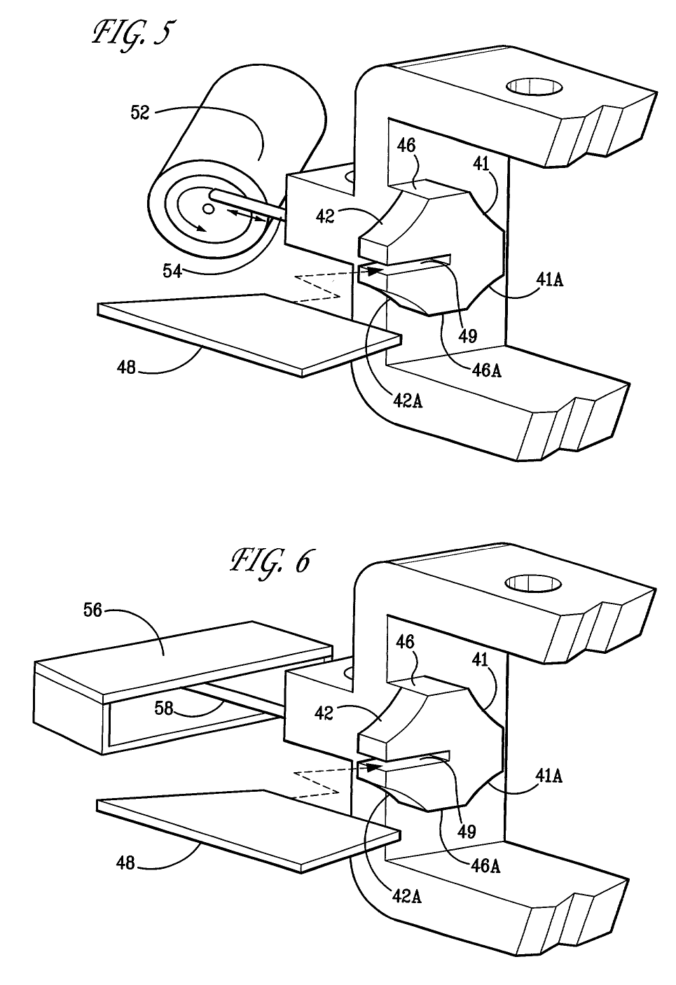

FIG. 6 shows an embodiment in which a voice coil motor, including coil 56, moves the connecting rod 58 in a motion which reciprocates cleaning pad 48 in the direction along the tracks of the magnetic disk. The voice coil motor can be similar to that used in the linear actuator.

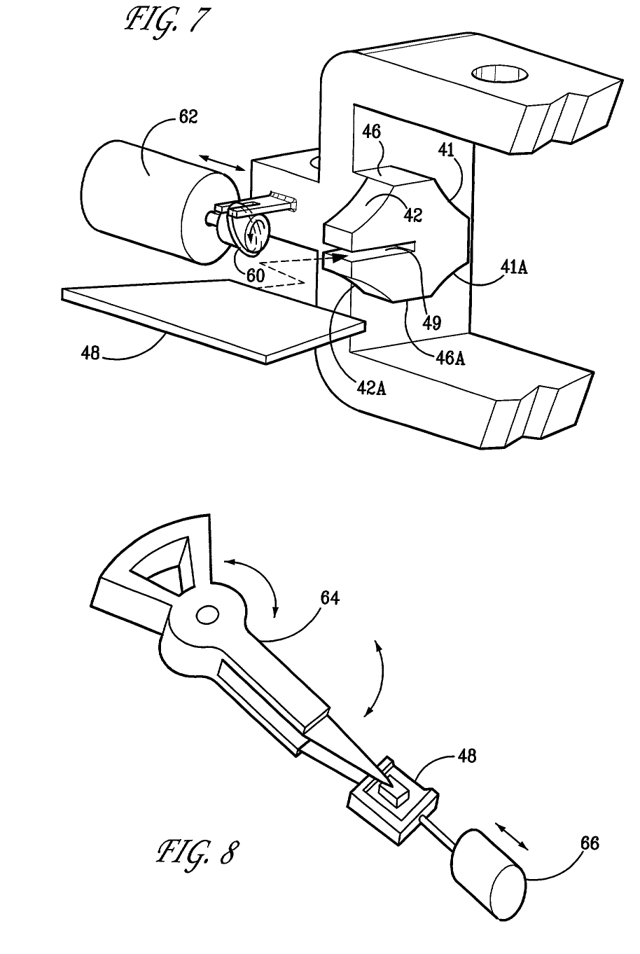

FIG. 7 depicts an embodiment in which a swash plate 60 converts the rotary motion of a motor 62 into a reciprocating motion which moves the cleaning pad 48 along the tracks of the disk. A swash plate is like a one half turn of right hand thread coupled to a one half turn of left hand thread, thereby closing on itself.

FIG. 8 shows a rotary actuator 64 of the type which is employed in the JAZ™ drive supplied by Iomega Corporation. As shown in FIG. 8 a linear motor such as a solenoid 66 moves the cleaning pad back and forth in the direction of track motion.

While particular embodiments of the invention have been shown and described various modifications are within the scope of the inventions. For example, piezoelectric or magnetostrictive actuators could replace the voice coil motor or solenoid to supply the linear motion of the pad in the along track direction. All such modifications within the true spirit and scope of the inventions are claimed.

We claim:

1. A drive for a data storage disk having concentric tracks of data thereon comprising:
a read/write head;
a spindle motor for rotating said disk so that data in said tracks can be write/read to and from said disk;
an actuator for moving said head to said tracks of said disk;
a cleaning pad for cleaning said head; and
a head cleaner which moves said head on said pad with relative motion between said head and said pad in the direction of motion along said tracks of said disk.

2. The drive recited in claim 1 wherein said head cleaner moves said pad in the direction of motion along the tracks of said disks.

3. The drive recited in claim 1 wherein said head cleaner reciprocates said cleaning pad across said head in the direction of motion along the tracks of said disk.

4. The drive recited in claim 1 wherein said actuator moves said head on said pad in the direction of the motion across the tracks of said disk.

5. The drive recited in claim 4 wherein a combination of motion along said tracks and across said tracks cleans debris from said head.

6 The drive recited in claim 1 wherein said head cleaner includes a solenoid which moves said pad relative to said head in the direction of movement along said tracks.

7. The drive recited in claim 1 wherein said head cleaner includes a voice coil motor which moves said pad relative to said head in the direction of movement along said tracks.

8. The drive recited in claim 1 wherein said head cleaner includes a swash plate which moves said pad relative to said head in the direction of movement along said tracks.

9. The drive recited in claim 1 wherein said head cleaner includes a rotary motor and a connecting rod connected to said pad to move said pad in a linear motion relative to said heads which is along said tracks.

10. The drive recited in claim 1 wherein said actuator is a rotary actuator.

11. The drive recited in claim 1 wherein said actuator is a linear actuator.

12. The drive recited in claim 1 wherein said disk is a magnetic storage disk.

13. The drive recited in claim 1 wherein said disk is a magneto-optical storage disk.

14. The drive recited in claim 1 wherein said disk is an optical storage disk.
